(19) United States
(12) Patent Application Publication
(10) Pub. No.: US 2013/0046781 A1
(43) Pub. Date: Feb. 21, 2013

(54) DESIGN, CREATION, AND DELIVERY OF PERSONALIZED MESSAGE/AUDIO-VIDEO CONTENT

(71) Applicants: ERIC FRANKEL, Los Angeles, CA (US); ARIEL JALALI, Los Angeles, CA (US); MARK E. CHODOS, Temple City, CA (US)

(72) Inventors: ERIC FRANKEL, Los Angeles, CA (US); ARIEL JALALI, Los Angeles, CA (US); MARK E. CHODOS, Temple City, CA (US)

(73) Assignee: StarGreetz, Inc., Los Angeles, CA (US)

(21) Appl. No.: 13/587,880

(22) Filed: Aug. 16, 2012

Related U.S. Application Data
(60) Provisional application No. 61/525,635, filed on Aug. 19, 2011.

(51) Int. Cl. G06F 17/30

(52) U.S. Cl. 707/769; 707/E17.014

(57) ABSTRACT

A computer implemented system and method for retailers, brands, manufacturers, service providers, and resellers to deliver personalized messages based on a script about their products to an end user. The end user data has been collected via end user input, a social media database containing user input, a CRM database query based on end user information, cookies and browser header from the end user net surfing, and second and third party data providers, etc. The system and method via a web application server accesses and stores the end user data. A media server retrieves the data and with a content management system having product templates defined by the script, accesses the media file server and processes the media clips to generate a personalized message. A content distribution network relays the personalized message to the web application server which delivers the personalized message to the end user.

### CROSS-REFERENCE TO RELATED APPLICATIONS

This application claims priority from U.S. Provisional Patent Application No. 61/525,635, filed Aug. 19, 2011, which contents are hereby incorporated by reference in their entirety. This application is further related to the following co-pending and commonly-assigned patent applications, which applications are hereby incorporated by reference in their entirety:

U.S. patent application Ser. No. 13/240,845, titled “POINT-OF-SALE PURCHASE PERSONALIZED MESSAGE,” by Eric Frankel, Ariel Jalali, and Mark E. Chodos, filed on Sep. 22, 2011; and

U.S. patent application Ser. No. 13/421,732, titled “PERSONALIZED MEDIA CONTENT BASED ON SOCIAL MEDIA WEBSITE DATA,” by Eric Frankel, Ariel Jalali, and Mark E. Chodos, filed on Mar. 15, 2012.

### BACKGROUND

Retailers, brands, manufacturers, service providers and other resellers extensively use internet websites, including social networks (e.g., Facebook™, Twitter™, etc.) to market and advertise their brands, products and services to consumers. Billions of dollars are spent annually on such marketing and advertising.

There are currently little to no methods by which to address such advertising personally to individuals by name or like personal attribute.

### SUMMARY OF THE INVENTION

Embodiments of the invention establish a computer implemented method and system for retailers, brands, manufacturers, service providers and other resellers to address their marketing and advertising messages about their products and services personally to individual consumers/users who view websites, including social networks, containing such advertisers' messaging.

Various alternative embodiments provide a computer system and computer implemented method for retailers, brands, manufacturers, service providers, and resellers to deliver personalized messages based on a script about their products to an end user, wherein end user data has been collected via at least one of (1) end user input, (2) a social media database containing user input, (3) a CRM database query based on end user information, (4) cookies and browser header from the end user net surfing, and (5) second and third party data providers, the computer implemented method comprising a web application server accessing the end user data and storing on a local database; a media server retrieving the end user data from the local database, the media server containing a content management system having at least one product template that is defined by the script applicable to multiple products; the media server accessing a media file server containing media clips presenting a product and a position, and processing at least one media clip based on the product template from the content management system and the end user data to generate a personalized message; a content distribution network receiving the personalized message from the media server and relaying the personalized message to the web application server; and wherein the web application server delivers the personalized message to the end user.

### BRIEF DESCRIPTION OF THE DRAWINGS

FIG. 1 is a dataflow diagram for various exemplary embodiments of the present invention system and method.

FIG. 2 is a graphical representation of the application and database schema for an exemplary embodiment of the present invention.

FIG. 3 is graphical representation of a sample personalized media script template.

FIG. 4 is an exemplary embodiment of a graphical user interface for a personalized digital product configuration and labeling.

FIG. 5 is a graphical representation of a preferred embodiment database schema for personalized media scheduling, API, product scripts, and user data.

### DETAILED DESCRIPTION OF THE PREFERRED EMBODIMENTS

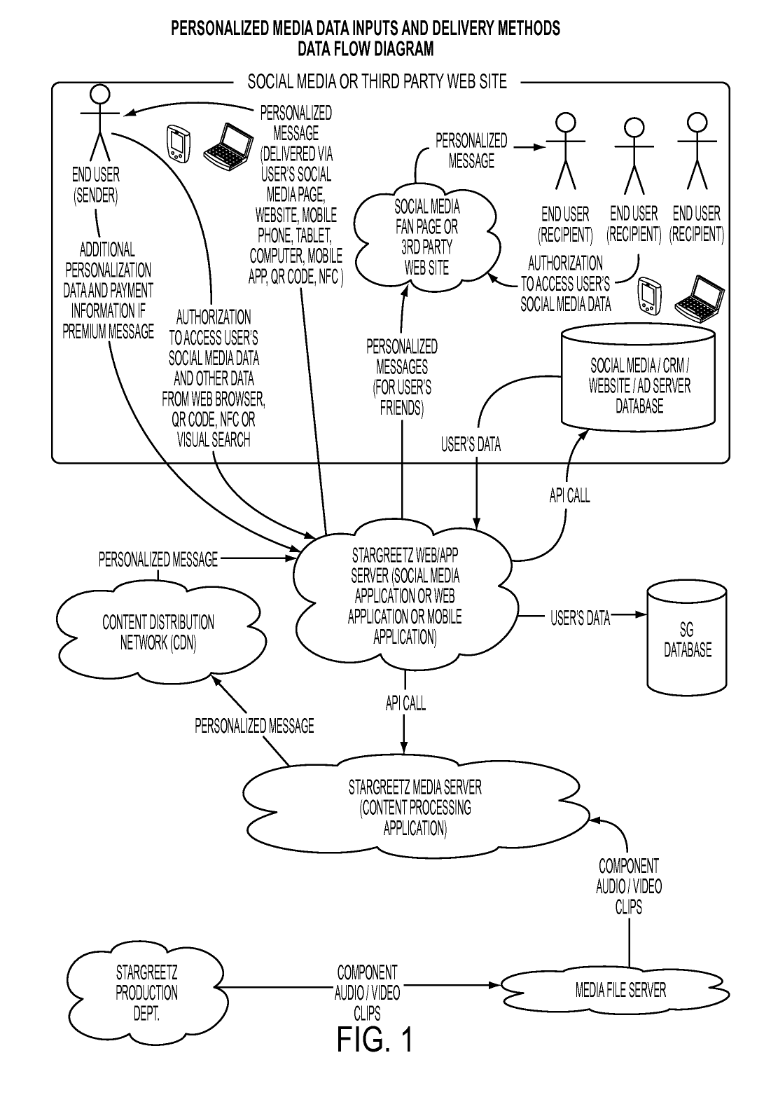

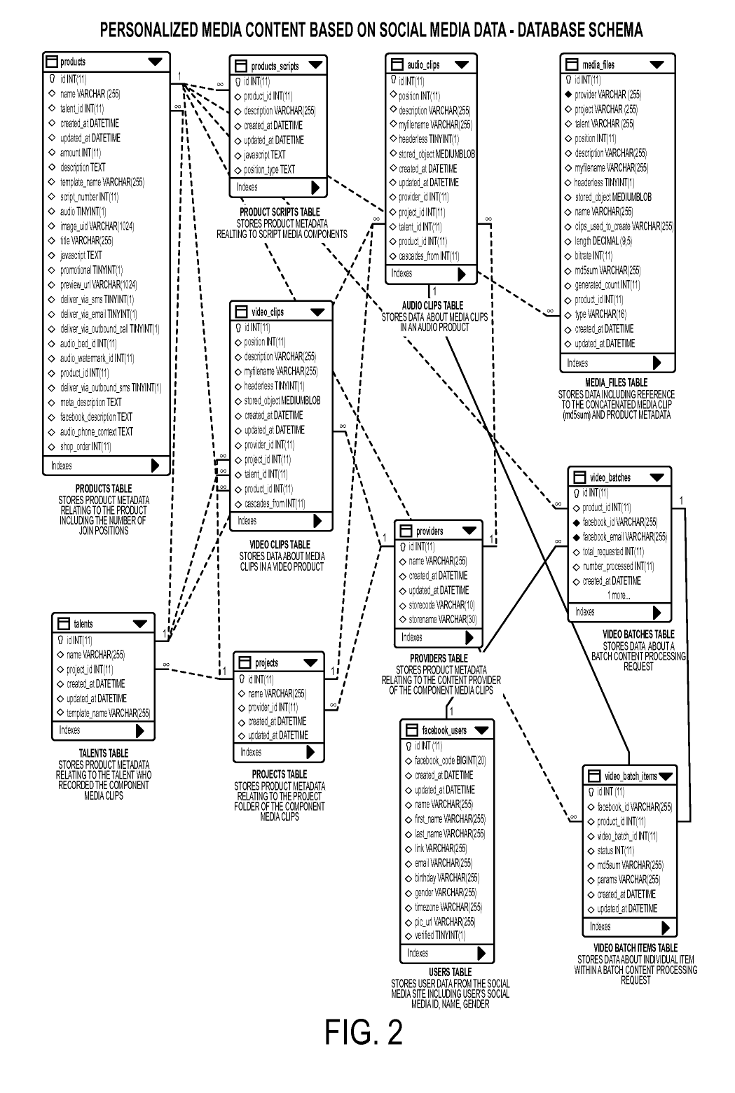

In various preferred embodiments depicted in FIGS. 1 and 2, the present invention contemplates a social media application that resides on one or more web/application servers and is responsible for obtaining data about an end user for the purpose of determining the selection of audio-video media clips for variable positions (defined below). This data may be obtained from the user's profile on social media sites or third party sites where users share data about themselves and/or through direct user input to the social media application. The social media application then submits a request to the content processing application to create one or more personalized messages based on the selected media clips. Once the personalized messages have been created, the social media application then delivers them to one or more of the end users.

In various alternative embodiments, the present invention further contemplates a computer system and a computer implemented method for retailers, brands, manufacturers, service providers, and resellers to deliver personalized messages based on a script about their products to an end user, wherein end user data has been collected via at least one of (1) end user input, (2) a social media database containing user input, (3) a CRM database query based on end user information, (4) cookies and browser header from the end user net surfing, (5) second and third party data providers (e.g., Neilson/Prism), (6) Near Field Communications (NFC) tag, and the like.

The present invention in an exemplary embodiment includes a content processing application that resides on one or more media servers. It receives requests from the social media application for personalized messages. It creates or retrieves the requested personalized messages and returns them to the social media application for further processing or distribution as described above.

### DEFINITIONS

“Product”: a product is a collection of digital media clips that can be combined to form personalized digital messages that are transmitted electronically to end users. A product consists of two or more “positions.” To create a “personalized message,” at least one position in the product must be a “variable position.” Information about products is stored in the products table in the SG (i.e., applicant StarGreetz) database or local database. A product is associated with other metadata such as a talent (i.e., an actor, singer, athlete, performer, model, celebrity, etc.) who stars in the media clips and a content provider who provides the talent to the project. The metadata are contained in respective tables in the SG Database, as depicted in FIGS. 1 and 2.

“Position”: A Position is a logical section of a product's message, e.g., the message recipient's name. Each position comprises one or more media clips. A position that comprises a single media clip is considered a static position, i.e., it is the same for every personalized instance of the product. A position that comprises more than one media clip is considered a “variable position,” i.e., it can differ from one personalized instance of the product to another. Information about positions is stored in the “product_scripts” table in the SG Database

“Media Clip”: A media clip is a digital file containing audio and/or video data that, when combined with other media clips, are used to create a personalized message. Information about media clips is stored in the “audio_clips” and “video_clips” tables in the SG Database.

“Personalized Message”: a personalized instance of a product. The personalized message comprises media clips from one or more variable positions that were selected for the end user based on direct end user input or through data obtained about the end user from other sources including social media websites, and may be combined with media clips from one or more static positions. Information about personalized messages is stored in the “media_files” table in the SG Database.

The preferred embodiment system includes two components: (1) a social media application; and (2) a content processing application.

(1) The Social Media Application

The social media application preferably resides on one or more web/application servers and is responsible for obtaining data about a user for the purpose of determining the selection of media clips for variable positions. This data may be obtained from the end user's profile on the social media sites or third party sites where users share data about themselves and/or through direct user input to the social media application. The social media application then submits a request to the content processing application to create one or more personalized messages based on the selected media clips. Once the personalized messages have been created, the social media application then delivers them to one or more end users.

The social media application in the preferred embodiment supports the following functionalities:

[a] To Send a Personalized Message to One User (Including Self).

Ability to select and personalize a product; and to preview, purchase and to send a personalized message from a sender to a recipient. Preconditions for the preferred embodiment social media application include the following: the end user is registered with a social media site or third party site (e.g., Facebook™); the end user is logged into a social media site or third party site (e.g., Facebook™); the media clips for all of the positions for a given product are stored on and available from the media file server. The social media application is coded to obtain information on one or more products from the SG Database and displays this information to the end user.

The social media application is coded to obtain a list of the positions for each product, and a list of the media clips for each position from the SG Database. For example, a list of available media clips for the position representing the message recipient's name may include ABBY, ADAM and so on. The end user grants the social media application permissions to access the user's data from the social media or third party website.

The social media application obtains the end user's data from social media site database via API call to the social media or third party website and stores it in the SG Database, in the Users table (e.g., Facebook_Users table in the database schema, as in FIG. 2). This data may include the end user's name, gender, location, birthday, online handle, interests, affiliations, etc. The interests may include hobbies, sports, foods, movies, games, music genres or bands, books, etc. The affiliations may include family members and extended relatives; fan clubs; school alumni; business associations; sports teams; commercial brands of clothing, vehicles, cosmetics, consumer products; popular following of entertainers, celebrities, artists, pop stars, sport stars; etc.

The end user selects a product that is displayed in the social media application user interface. The social media application uses the end user's social media data obtained from the social media or third party website to determine the selection of the media clips for one or more of the variable positions of the selected product. The social media application may also use data obtained through direct user input to the social media application to determine the selection of the media clips for certain variable positions.

The IDs of the selected media clips for each position of the selected product are passed via API call as a request to the content processing application to create the personalized message. The content processing application integrates the end user's social media data with the media clips to generate the personalized message, and places it on a content delivery network or content distribution network (CDN), and optionally returns a reference to it to the social media application. The content processing application is described in greater detail in section (2) below. The end user can then use a media player in the social media application to play the personalized message.

Alternatively, if the product has been designated as premium (paid) content, the end user pays for the content in the social media application interface by providing his or her payment credentials (e.g., PayPal™, Google Wallet™, credit card, etc., or credits that have value on the social media or third party website). The user can also electronically send the personalized message to his page on the social media or third party website, or to a friend's page.

[b] Optionally, To Send a Personalized Message to Many Recipients

In this option, the algorithm is the same as sending personalize messages to one user described above, but instead of one by one, requests for personalized messages from a sender/end user to multiple recipients are submitted as a batch (video_batch table in the SG Database) and placed by the social media application into a queue. Each item in the queue is referenced by unique ID in the video_batch_items table of the SG Database.

Each request in the queue to create the personalized message is sent to the content processing application. The content processing application creates the personalized message for each recipient and stores it on the content distribution network.

The social media application may monitor the queue to let the user know what percentage of request for the user's batch is completed. When all of the requests have been completed by the content processing application, the social media application posts the personalized messages to each recipient's page on the social media site or third party site, and notifies the sending user that their batch of requests has been completed. Alternatively, the personalized messages may be posted to each recipient's page as soon as the message has been completed (e.g., rather than waiting until all messages are complete). Further, the requesting sender may be provided with the option of when to receive notifications (e.g., during processing on a per personalized message completion versus when all personalized messages are complete) and when to post personalized messages to recipient's web pages.

[c] To Play a Personalized Message on an End User's Social Media Page, Social Media Fan Page, Social Media Wall or News Feed or Third Party Website Via Button Click

This alternative embodiment allows the ability to place a specifically formatted post on a page of a social media site or third party site, and have that post play a personalized message on the social media site or third party site which can be shared with other members of the site.

Preconditions include the following: the end user is registered with a social media site or third party site (e.g., Facebook™). The end user is logged into a social media site or third party site (e.g., Facebook™). Media clips for all of the positions for a given product are stored on and available from the media file server. The social media application is coded to obtain information on one or more products from the SG Database. The social media application is coded to obtain a list of the positions for each product, and a list of the media clips for each position from the SG Database. For example, a list of available media clips for the position representing the message recipient's name may include ABBY, ADAM, and so on. A specifically formatted post is placed on a page on a social media site or third party site. Embedded in this post are links to the social media application and references to a specific product.

In use, the end user clicks on the specifically formatted post. The end user is asked to grant permission to the social media application to access the user's social media data from the social media site or third party site. The end user grants the social media application permission to access the end user's data from the social media site or third party site.

The social media application obtains the end user's social media data from social media site database via API call to the social media or third party website and stores it in the SG Database, in the Users table (e.g., Facebook_Users table in the database schema, FIG. 2). This data may include the user's name, gender, location, etc.

The social media application uses the data obtained from the social media or third party website to determine the selection of the media clips for one or more of the variable positions of the product referenced by the specifically formatted post. The IDs of the selected media clips for each position of the referenced product are passed via API call as a request to the content processing application to create the personalized message. The content processing application creates the personalized message and places it on the content distribution network, and optionally returns a reference to it to the social media application. The user can then play the personalized message using a media player embedded in the specifically formatted post on the social media or third party website. The end user may optionally send the personalized message to his or her page on the social media or third party website, or to a friend's web page.

[d] To Play a Personalized Message on a User's Social Media Page, Social Media Fan Page, Social Media Wall or News Feed or Third Party Site Via Instant Personalization

This alternative embodiment contemplates the ability to place a specifically formatted post on a page of a social media site or third party site, and have that post play a personalized message on the social media site or third party site which can be shared with other members of the site.

Preconditions for this embodiment include: The end user is registered with the social media or third party website (e.g., Facebook™). The end user is logged into a social media site or third party website (e.g., Facebook™). The media clips for all of the positions for a given product are stored on and available from the media file server. The social media application is coded to obtain information on one or more products from the SG Database. The social media application is coded to obtain a list of the positions for each product, and a list of the media clips for each position from the SG Database. For example, a list of available media clips for the position representing the message recipient's name may include ABBY, ADAM, and so on. A specifically formatted post is placed on a page on a social media site or third party site. Embedded in this post are links to the social media application and references to a specific product. The host site has an agreement with social media site or third party site that allows it to authenticate visitors to the host site who are registered with and logged into social media site or third party site.

In use, the end user clicks on the specifically formatted post. The algorithm in this alternative embodiment is the same flow as in embodiment [c] above, except the end user does not have to grant permission to the social media application to access the end user's data from the social media site, since this permission has already been granted through the “Instant Personalization” agreement between the host site and the social media site.

(2) The Content Processing Application

In the preferred embodiment, the content processing application resides on one or more media servers. It receives requests from the social media application for personalized messages. It creates or retrieves the requested personalized messages and returns them to the social media application.

A request for a personalized message consists of a string containing a list of media clips (referenced by ID), the position to which each media clip belongs, and the product to which the requested personalized message belongs. The content processing application calculates the md5sum (a unique identifier for the personalized message based on the MD5 [Message-Digest algorithm 5] hashing or checksum function/algorithm—a cryptographic hash function with a 128-bit hash value) for the requested personalized message, and queries the SG Database to see if that MD5sum exists in the media_files table. If it does, this personalized message has already been created and stored on the content distribution network, and the content processing application simply returns a reference to the location of the personalized message on the content distribution network to the social media application.

If the MD5sum is not found in the media_files table, then the content processing application must create the personalized message. First, it retrieves each of the media clips, either from a locally cached copy on the media server, or, if a clip is not in the local cache, from the media file server. The media clips are then combined to create the personalized message. The process used to combine the clips for audio only products is different from the process used to combine video products. These processes are described in greater detail below. Once the personalized message has been created, it is stored on the content distribution network, and information about it (including its MD5sum or checksum) is stored in the media_files table of the SG Database.

Below is exemplary embodiment code for content processing for audio.

| | |
|---|---|
| 26 | Self.clips_used_to_create.split(“,”).each do \|f\| |

| | |
|---|---|
| 27 | begin |

| | |
|---|---|
| 28 | if (product.audio_watermark.present? and |

product.audio_watermark.id == f.to_i) or

| | |
|---|---|
| 29 | (product.audio_bed.present? and |

product.audio_bed.id == f.to_i) then

| | |
|---|---|
| 30 | Nil |

| | |
|---|---|
| 31 | Else |

32

tf.print(AudioClipRedis.grab(f).stored_object)

| | |
|---|---|
| 33 | End |

| | |
|---|---|
| 34 | Rescue |
| 35 | End |

| | |
|---|---|
| 36 | End |
| 37 | tf.close( ) |
| 38 | system(“sox -c1 -r 48000 -t raw -L -s -2 |

#{tf.path} -t wav #{tf.path}.wav”)

| | |
|---|---|
| 39 | if product.audio_bed.present? then |

| | |
|---|---|
| 40 | Tf2 = Tempfile.new(‘ab_encoding’, |

tmpdir=‘/dev/shm’) # use the tmpfs filesystem. no
disk i/o :)

| | |
|---|---|
| 41 | Tf2.print(product.audio_bed.stored_object) |
| 42 | Tf2.close( ) |
| 43 | system(“sox -c1 -r 48000 -t raw -L -s -2 |

#{tf2.path} -t wav #{tf2.path}.wav”)

| | |
|---|---|
| 44 | system(“sox -M #{tf2.path}.wav ‘\|sox |

#{tf.path}.wav -p pad 0’ -c 1 -r 48000
#{tf.path}.2.wav trim 0 \grave{ }soxi -D #{tf.path}.wav\grave{ } &&
mv #{tf.path}.2.wav #{tf.path}.wav”)

| | |
|---|---|
| 45 | End |

| | |
|---|---|
| 110 | def transcode(tempFile, quality) |

| | |
|---|---|
| 111 | if quality then |

| | |
|---|---|
| 112 | system(“export TERM=vt100; lame -m m -r |

#{quality.settings} -S #{tempFile}.raw
#{tempFile}.mp3”)

| | |
|---|---|
| 113 | Else |

| | |
|---|---|
| 114 | system(“export TERM=vt100; lame -m m -r -s |

48000 -b 40 -S #{tempFile}.raw #{tempFile}.mp3”)

| | |
|---|---|
| 115 | End |

| | |
|---|---|
| 116 | End |

The component media clips for an audio product are stored on the media file server in “way” format. The component media clips are concatenated by “printing” them sequentially to a stored object file (lines 26-37).

Header meta-data files are re-indexed and an optional audio bed may be added using SoX (Sound exchange) encoder under the GPL license (lines 38-45 above).

The file may then be transcoded to mp3 (Motion Picture Experts Group Audio Layer 3) format using any type of mp3 encoder (e.g., the LAME™ mp3 encoder (lines 110-116 above)). Alternatively, other formats/types of media content files can be used (e.g., AVI, WMV, etc.).

The resulting personalized message is stored on the content delivery/distribution network (CDN) and a reference to it is stored in the media_files table of the SG Database, in the MD5sum field (or other identification field such as a checksum). The MD5sum is a unique identifier to the processed media file.

Below is exemplary embodiment code for content processing for video.

| | |
|---|---|
| 67 | #Split Files |
| 68 | Clip_ids.each do \|clip_id\| |

| | |
|---|---|
| 69 | system(“export TERM=vt100; cd #{working_dir}; |

MP4Box -raw 1 #{clip_id}.mp4; MP4Box -raw 2
#{clip_id}.mp4;”)

| | |
|---|---|
| 70 | End |

71

| | |
|---|---|
| 72 | video_merge = clip_ids.map{ \|x\| |

“#{x}_track1.h264” } * “ ”

| | |
|---|---|
| 73 | audio_merge = clip_ids.map{ \|x\| “#{x}_track2.aac” |

} * “ ”

74

| | |
|---|---|
| 75 | #Concatenate Files |
| 76 | system(“export TERM=vt100; cd #{working_dir}; cat |

#{video_merge} > concatenated_video.h264; cat
#{audio_merge} > concatenated_audio.aac”)

77

| | |
|---|---|
| 78 | #Merge Audio/Video |
| 79 | system(“export TERM=vt100; cd |

#{working_dir};MP4Box -add
\“concatenated_video.h264:fps=24.2\” -add
\“concatenated_audio.aac\” af_encoding.mp4”)

The component clips for a video product are stored on the media file server as H.264 encoded video and AAC encoded audio in an .mp4 container. Alternatively, the component clips may be stored and/or encoded in any other type of format (e.g., MOV).

First, each component clip video into a video stream and an audio stream (lines 67-70 above). Next, a string is created that references all the component video files and another string that references all the component audio files (lines 71-74 above). Next, the video streams and the audio streams separately concatenated (lines 75-76 above).

Finally, a new stored object is created composed of the concatenated video stream and concatenated audio stream in an .mp4 container (or other format), using a multiplexer (e.g., MP4Box™) (lines 78-79). The concatenated file is stored on the content distribution network and a reference to it is stored in the media_files table of the SG Database, in the MD5sum field. The MD5sum is a unique identifier for the personalized message, based on the MD5 hashing algorithm.

### I. Definitions for Alternative Embodiments

“Product”:

A Product is a collection of digital Media Clips that can be combined to form personalized digital messages that are transmitted electronically to end users. A Product consists of 2 or more Positions. To create a Personalized message, at least one Position in the Product must be a Variable Position. Information about Products is stored in the “products” table in the SG Database or local database. A product is associated with other metadata such as a Talent (person or character that is the central figure in the Media Clips) and a Content Provider who provides the Talent to the Project—all respective tables in the SG Database.

“Position”:

A Position is a logical section of a Product's message (e.g., the message recipient's name). Each position comprises one or more Media Clips. A Position that comprises a single Media Clip is considered a Static Position (i.e., it is the same for every personalized instance of the Product). A Position that comprises more than one Media Clip is considered a Variable Position (i.e., it can differ from one personalized instance of the Product to another). Information about Positions is stored in the “product scripts” table in the SG Database.

“Media Clip”:

A Media Clip is a digital file containing audio and or video data that, when combined with other Media Clips, can be used to create a Personalized Message. Information about Media Clips is stored in the “audio_clips” and “video_clips” tables in the SG Database.

“Personalized Message”:

A personalized instance of a Product. The Personalized Message comprises Media Clips from one or more Variable Positions that are selected for the user based on direct user input or through data obtained about the user from other sources, including social media sites, and may be combined with Media Clips from one or more Static Positions. Information about Personalized Messages is stored in the “media_files” table in the SG Database or local database. Furthermore, the terms “end user,” “user,” “sender,” and “recipient” of the personalized message are used interchangeably depending upon the specific embodiment of the present invention system and method, and those skilled in the art understand how each interacts with those specific embodiments.

“Script”:

Script is the dialog/instructions that will direct and inform the Talent what to say and/or do during a recording session to produce the different Media Clips. The Script identifies the Variable Positions and Static Positions for a Product.

“Content Processing Application”:

The Content Processing Application resides on one or more Media Servers. It receives requests from the Social Media Application for Personalized Messages. It creates or retrieves the requested Personalized Messages and returns them to the Social Media Application.

A request for a Personalized Message consists of a string containing a list of Media Clips (referenced by ID), the Position to which each Media Clip belongs, and the Product to which the requested Personalized Message belongs. The Content Processing Application calculates the MD5sum (a unique identifier for the Personalized Message based on the MD5 hashing algorithm) for the requested Personalized Message, and queries the SG Database to see if that MD5sum exists in the media_files table. If it does, this Personalized Message has already been created and stored on the Content Distribution Network, and the Content Processing Application simply returns a reference to the location of the Personalized Message on the Content Distribution Network to the Social Media Application.

If the MD5sum is not found in the media_files table, then the Content Processing Application must create the Personalized message. First it retrieves each of the Media Clips, either from a locally cached copy on the Media Server, or, if a clip is not in the local cache, from the Media File Server. The Media Clips are then combined to create the Personalized Message. The process used to combine the clips for audio only Products is different from the process used to combine video Products. These processes are described in greater detail below. Once the Personalized Message has been created, it is stored on the Content Distribution Network, and information about it (including its MD5sum) is stored in the media_files table of the SG Database.

Content Processing for Audio

| | |
|---|---|
| 26 | Self.clips_used_to_create.split(“,”).each do \|f\| |

| | |
|---|---|
| 27 | begin |

| | |
|---|---|
| 28 | if (product.audio_watermark.present? and product.audio_watermark.id == |

f.to_i) or

| | |
|---|---|
| 29 | (product.audio_bed.present? and product.audio_bed.id == f.to_i) then |
| 30 | nil |

| | |
|---|---|
| 31 | else |

| | |
|---|---|
| 32 | tf.print(AudioClipRedis.grab(f).stored_object) |

| | |
|---|---|
| 33 | end |

| | |
|---|---|
| 34 | rescue |
| 35 | end |

| | |
|---|---|
| 36 | End |
| 37 | tf.close( ) |
| 38 | system(“sox -c1 -r 48000 -t raw -L -s -2 #{tf.path} -t wav #{tf.path}.wav”) |
| 39 | if product.audio_bed.present? then |

| | |
|---|---|
| 40 | Tf2 = Tempfile.new(‘ab_encoding’, tmpdir=‘/dev/shm’) # use the tmpfs |

filesystem. no disk i/o :)

| | |
|---|---|
| 41 | Tf2.print(product.audio_bed.stored_object) |
| 42 | Tf2.close( ) |
| 43 | system(“sox -c1 -r 48000 -t raw -L -s -2 #{tf2.path} -t wav #{tf2.path}.wav”) |
| 44 | system(“sox -M #{tf2.path}.wav ‘\|sox #{tf.path}.wav -p pad 0’ -c 1 -r 48000 |

#{tf.path}.2.wav trim 0 \grave{ }soxi -D #{tf.path}.wav\grave{ } && mv #{tf.path}.2.wav
#{tf.path}.wav”)

| | |
|---|---|
| 45 | End |

| | |
|---|---|
| 110 | def transcode(tempFile, quality) |

| | |
|---|---|
| 111 | if quality then |

| | |
|---|---|
| 112 | system(“export TERM=vt100; lame -m m -r #{quality.settings} -S |

#{tempFile}.raw #{tempFile}.mp3”)

| | |
|---|---|
| 113 | Else |

| | |
|---|---|
| 114 | system(“export TERM=vt100; lame -m m -r -s 48000 -b 40 -S |

#{tempFile}.raw #{tempFile}.mp3”)

| | |
|---|---|
| 115 | end |

| | |
|---|---|
| 116 | End |

The component Media Clips for an audio Product are stored on the Media File Server in “way” format (or wma for Windows®, m4a, m4p for iTunes®, Broadcast Wave Format BWF, mp3, or related audio formats). The component Media Clips are concatenated by “printing” them sequentially to a stored object file (lines 26-37).

Header meta-data files are re-indexed and an optional audio bed may be added using SoX (Sound exchange) encoder under the GPL license (lines 38-45).

The file may then be transcoded to mp3 format using the LAME mp3 encoder under the GPL license (lines 110-116).

The resulting Personalized Message is stored on the Content Distribution Network (CDN) and a reference to it is stored in the media_files table of the SG Database, in the MD5sum field. The MD5sum is a unique identifier to the processed media file.

Content Processing for Video

| | |
|---|---|
| 67 | #Split Files |
| 68 | Clip_ids.each do \|clip_id\| |

| | |
|---|---|
| 69 | system(“export TERM=vt100; cd #{working_dir}; |
| | MP4Box -raw 1 |

#{clip_id}.mp4; MP4Box -raw 2 #{clip_id}.mp4;”)

| | |
|---|---|
| 70 | End |

71

| | |
|---|---|
| 72 | video_merge = clip_ids.map{ \|x\| “#{x}_track1.h264” } * “ ” |
| 73 | audio_merge = clip_ids.map{ \|x\| “#{x}_track2.aac” } * “ ” |

74

| | |
|---|---|
| 75 | #Concatenate Files |
| 76 | system(“export TERM=vt100; cd #{working_dir}; cat |
| | #{video_merge} > |

concatenated_video.h264; cat #{audio_merge} >
concatenated_audio.aac”)

77

| | |
|---|---|
| 78 | #Merge Audio/Video |
| 79 | system(“export TERM=vt100; cd #{working_dir};MP4Box |
| | -add |

\“concatenated_video.h264:fps=24.2\” -add
\“concatenated_audio.aac\”
af_encoding.mp4”)

The component clips for a video product are stored on the Media File Server as H.264 encoded video and AAC encoded audio in an .mp4 container.

First, each component clip video is split into a video stream and an audio stream (lines 67-70 above).

Next, a string is created that references all the component video files and another string that references all the component audio files (lines 71-74 above).

Next, the video streams and the audio streams are concatenated separately (lines 75-76 above).

Finally, a new stored object is created and stored comprised of the concatenated video stream and concatenated audio stream in an .mp4 container, using MP4Box, an MP4 multiplexer under the GPL license. (lines 78-79 above).

The concatenated file is stored on the Content Distribution Network (CDN) and a reference to it is stored in the media_files table of the SG Database, in the MD5sum field. The MD5sum is a unique identifier for the Personalized Message, based on the MD5 hashing algorithm.

### II. Alternative Embodiments

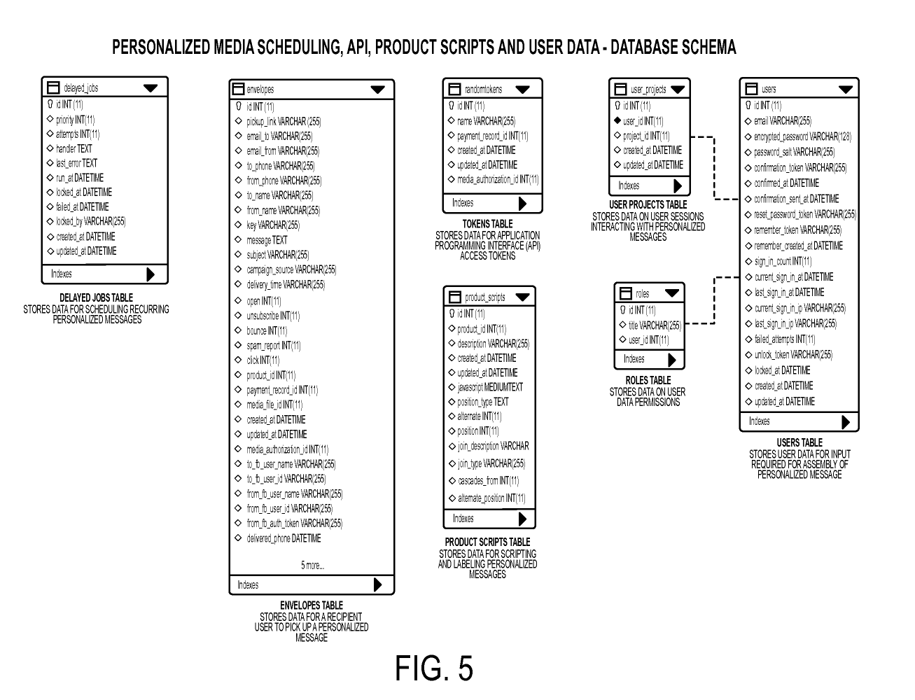

As seen in the dataflow diagram of FIG. 1 and the database schema of FIG. 5, the present invention in various alternative embodiments is directed to a computer system and computer implemented method for retailers, brands, manufacturers, service providers, and resellers to deliver personalized messages based on a script about their products to an end user, wherein end user data has been collected via at least one of (1) end user input, (2) a social media database containing user input, (3) a CRM database query based on end user information, (4) cookies and browser header from the end user net surfing, and (5) second and third party data providers, the computer implemented method comprises a web application server accessing the end user data and storing on a local database; a media server retrieving the end user data from the local database, the media server containing a content management system having at least one product template that is defined by the script applicable to multiple products; the media server accessing a media file server containing media clips presenting a product and a position, and processing at least one media clip based on the product template from the content management system and the end user data to generate a personalized message; a content distribution network receiving the personalized message from the media server and relaying the personalized message to the web application server; and wherein the web application server delivers the personalized message to the end user.

(1) Scripting—Creation and physical production of Script in accordance with pre-defined template to enable efficient integration with a content management system to produce/create personalized message (i.e., media/audio-video content).

Overview

The Script is designed in a manner that Positions can be shot or Audio-Video recorded and assembled for input into a Content Management System (CMS). Scripts can be used for audio and/or video products.

Scripting Process

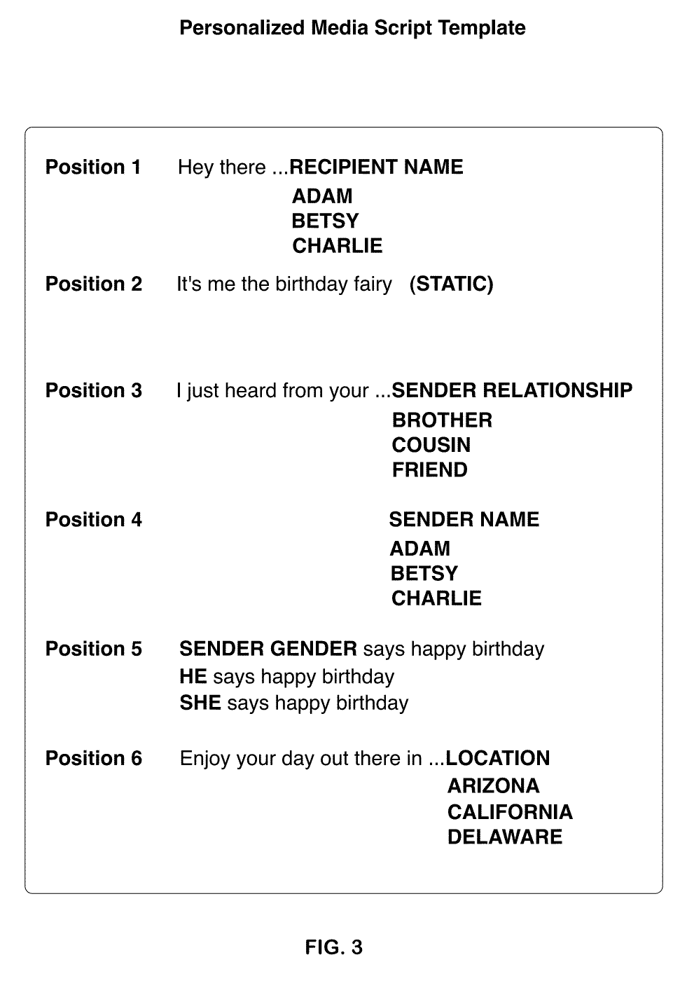

As depicted graphically in FIG. 3, a writer authors the Script specifying the various Positions in the Product. A director who supervises the asset recording process follows the Script guidelines to make sure that the assets are recorded and filmed (in the case of video), so that they can be edited into media clips for product positions. When the recording or filming session is complete, raw assets are generated. There is a digital file folder for each set of raw assets, generally corresponding to the positions. There is one raw file for each set of variables in a position. For example, if the position is a list of names, a single media file with names A thru Z recorded (e.g., Adam, Andrea, . . . Xander). A creative manager gives video and audio editors verbal and written directions on editing the assets into media clips. Editors cut the raw assets into variable and static media clips. Editors respond by uploading actual files to a shared drive on the network. If video, editors provide two video file formats, compressed files for loading into the CMS and uncompressed files for previewing and performing quality assurance prior to loading. Sometimes variable positions impact other positions in the script (e.g., if variable position 1 is vehicle, the options may include “car” or “boat”; and options for variable position 3 distinguish the vehicle's color, such as “blue” or “red”, then based upon the users selections, the finished product would denote a “blue car” or “blue boat”). In this example, the variable options in position 3, will be limited to the options pertaining to the selected option in variable 1.

Template Definition and Editing Process

Each product has a specified template, shown in FIG. 3, that is defined by the Script. The template contains all pertinent information from the Script and is divided according to the various products that form the Script in its entirety. The following are a list of possible product templates:

Ringtone—Personalized audio or video file that can be set as ringing sound or movie played when mobile phone or tablet device is called.

Ringback—Personalized audio or video file that can be set as sound to entertain callers who call a user's mobile device, tablet, or computer. These are set by the connection provider, e.g., mobile carrier.

Audio Greeting—Personalized audio message made by a sender to be played by a recipient.

Mobile Alert—Personalized audio or video file that can be set as phone sound or movie played when mobile phone or tablet device receives a new message or other system notification.

eCard—Personalized video message made by a sender to be played by a recipient.

elnvitation—Personalized audio or video message made by an event host to be played by one or more event guests.

Social Media Broadcast Message—Personalized audio or video message delivered to members of a social network via push notification message when then user is logged into the social network site, e.g., Facebook™ newsfeed.

Social Media Page Welcome Message—Personalized audio or video message delivered to visitors of a social media page or website that allows a user to authenticate and allow a social media app. Welcomes the user to the page by personally greeting him.

CRM message—Personalized audio or video message that is pre-generated or generated at the time of user pick up based on input variables imported and matched to variables in product positions

The template of FIG. 3 ensures that each variable within the product positions will fit together exactly when concatenated together in the personalized message and to ensure that there are no lapses in concatenated versions of the personalized message. Each template provide a structured timeline that indicates the total duration of the personalized message and duration of each position contained within the message. For example, a position may have individual media clips with a running times of 10 seconds—each variable within said position must have a running time of 10 seconds.

The product template can be created in any media editing software (e.g., for video Apple Final Cut Pro). A master product is created using the template and contains one media clip for each position. This serves as a reference for the editing process. Generally, names are at the beginning, so as to allow for extension of the products length at one end, rather than disrupting the mechanisms that govern the core central portion of the product. Variable positions may differ in length (i.e., 5 or 10 seconds), however media clips within a position will be uniform in length. Scripts are modified before filming to try and make sure it fits into master. The timeline is built as an average of different variables in the various positions and variables are shortened or expanded to fit the timeline, in the editing process.

Additionally, the template determines which media clips may be used in multiple locations for various products. For example, the color variable may be utilized in an eCard as position 3, however, the same media clip may serve as position 2 in a Facebook™ poke. Utilizing media clips in numerous products allows production to be more efficient in the recording process.

In the rare event that editors are unable to create media clips of identical lengths for a particular position, a second master may be generated, as well as files for all subsequent positions. For example, in a product comprised of 13 positions, if several variables contained within position 7 exceed the lengths of the other variables, editors will need to generate differing files for positions 8-13, which would coordinate with the second master. Though, the files may be identical to the first master, music cues or other visual effects may need to be adjusted to accommodate the discrepancies in position 7.

Name field in Products Table is the “Product Type.” Business logic in application controller determines what specific position order must be enforced for a specific template. For example, an eCard contains both a Sender Name and a Recipient Name.

(2) Personalized Digital Product Configuration and Labeling Process

Asset Naming/Labeling

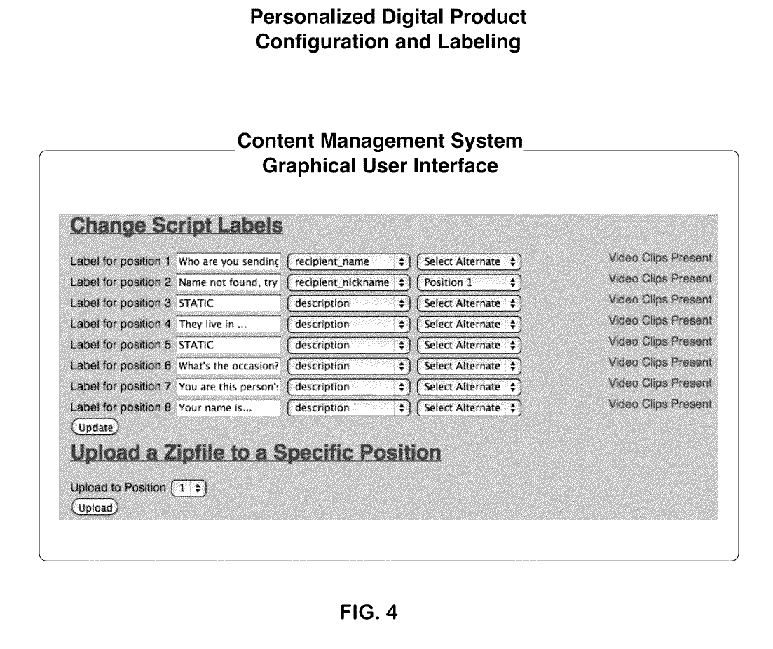

The template also establishes the naming conventions used for files, depicted graphically in FIG. 4. Taking into account the user experience (media clip file names are what the end user sees when generating a product), products are named in a manner that simplifies the process. For example, if the product asks for the user to indicate the color of their vehicle, files may be called “blue,” “red,” or “black.” For static positions, files are named “static_01,” which would indicate the file is the first static position.

Variable position media clips may be duplicated for different variations of variable position. For example, name homonyms may be generated from an existing raw asset (e.g., Eric, Erik, Eryk). This enables production to record only one variation of the name, thus curbing the length of time of the production shoot.

Map/Tag Position Clip Asset to Specific Product

Once the assets have been edited, labeled/named, and verified for quality assurance, the assets are then loaded/mapped to specific products within the Content Management System (CMS), again shown in FIG. 4. Every product is created in the CMS. The positions of the product are then mapped. For each position, specific language in the template, often in the form of questions, determined what markers users will see to aid in selection of variables within a position (i.e., what color is your car?). Once the product has been mapped and created, the files are uploaded into the CMS.

Map and Tag Product to Specific Delivery Mechanism/Storefront/Category

Once the products have been created in the CMS, assets loaded in each individual position, and passed through a rigorous final round of quality assurance, sample products are generated for users to get a quick view of the product in its entirety. Only then are the products ready to be tagged for the numerous forms of distribution (e.g., storefront, talent fan page, talent Facebook™ page, etc.).

Tags are concise words that prompt appearance of products in specific locations for distribution or sale. Tags are specific to products and not positions. For example, a birthday eCard would be broadly marketed across numerous distribution channels, and tagged accordingly. Tags such as “storefront,” “fanpage,” “iPhone,” “Android,” “birthday,” “eCard,” etc., would determine where the product would be available for distribution, viewing or sale to users. Examples include applying the tag “storefront” makes the product appear on applicant StarGreetz's shop (www.stargreetz.com/shop). The tag “iPhone” makes it appear in the StarGreetz iPhone app and the tag “birthday” makes it appear in the birthday sections of all storefronts. Individual tags may direct mapping to multiple distribution channels (e.g., “eCard” will allow for eCards to be distributed on various storefronts). If a product contains the tags “storefront” “iPhone” and “birthday,” it appears in the birthday section of both shop and iPhone.

Tags may also be dependent upon one another. For example, in order for a product to appear in the storefront under a particular category, such as Holidays, the product must be tagged “storefront” in addition to “Christmas.” Without the “storefront” tag, the product will not be seen by users browsing the product offerings under holidays.

(3) Graphical User Interface Design for Specific Personalized Message

Personalized Message Specific Script Label Creation

Determine text to be displayed to user specific to a particular personalized message (e.g., wake-up call, website message, etc.).

Product specific. Each product has positions. Some are variable and some are static. The variable positions have script labels that describe the position, e.g., “What occasion are you celebrating?” and variable names, e.g., “bar mitzvah, graduation . . . ”

Text examples: “where do you live?” or “what is your favorite Reba song?”

This text defines the GUI presentation for a particular personalized message. These are script labels for a variable position.

Map text to a specific variable position name

Providing a script variable name that corresponds to each potential variable position the value for the variable has the different options/selections that are permissible, e.g., drop down list has all the states listed or names or hobbies, etc.

Alternatively, provide a label name (i.e., identify the variable name that will be used to store the variable position value) to be received by the CMS so that third parties can make their own interface via an API Personalized Message Specific Script Label Creation may limit user input based on prior responses (“Cascading”) certain variable selections cascade from one to another. Occasion for card, e.g., happy b-day, at end of card, it will repeat, happy b-day from your friend.

In other words, do not ask user same question twice. The answer provided by user will cascade down. Once all the selections have been made by the user (or received from a third party via an API), the next task is to match the selections to the appropriate positions in order create the concatenated personalized message that will be delivered.

“Description” in the Products Scripts table is where the label name is stored. “Position Type” in the Products Scripts table contains semantic meaning of what type of position it is and application can perform business logic to validate the fields and construct the user interface accordingly. Some examples include:

Name: Usually the largest number of values as these are values for possible user first or last names.

Static: Position with only one media clip and no variables.

Gender: Male, Female or Gender Neutral default.

Cascades From: Assigned from another position such as if a user's name is said more than once in script.

System Defined: Selected based on system values such as time or location triggers, e.g., “Sale starts in 3 days, 2 days, or Today” based on countdown.

(4) Personalized Video and Audio Content Based on User Configured, System Configured, and Hybrid Configured Information

Precondition: Loading a product that can be personalized, and all the associated clips used to create it, into the CMS as described in Scripting and Product Configuration processed above.

User Configured Data

Information based on event initiated by the user. A user goes to a website, microsite, iFrame, widget, mobile device app, or mobile site where a product is offered for personalization and pulls down options from a drop down menu, enters text into input boxes, checks radio buttons, sliders, check boxes or other interface elements to select variables for each variable position in the product. Once selections have been completed, the user selects a submit button.

System Configured Data

Information based on knowledge base maintained or accumulated by CMS. Examples include date, time, weather, news, etc.

CRM (Customer Relationship Management) personalized message.

Strategy for managing a company's interactions with customers, clients and sales prospects. CMS pulls up time and location data, weather and date and matches it to variable positions in the SG Database and provides input to matching process. The personalized CRM message is generated by a script run on a server where the trigger could be time based. Hybrid Configured Information can also be taken as an input to the process

QR Code

Quick Response (QR) code—specific matrix barcode (or 2D code) readable by dedicated QR barcode readers and camera phones. QR codes when scanned by an iPhone, smartphone, tablet, or like mobile device or reader, provide typically a link to a website, and can store text, email addresses, telephone numbers, etc. It is contemplated to embed personalization data into QR codes (or bar codes). The QR code is a CRM product as well as an activation product could include personalization variables such as name, location (off of browser—e.g., “Macy's store #13”), time, etc., into the QR code. The QR code can launch onto a web browser and have user input data such as wife's name and then use combination as a trigger to provide personalization. For instance, a male user going to a retail store, e.g., Macy's, with girlfriend, that user scans one QR code and gets one response for men's blazers, while girlfriend scans same QR code and gets a second response for women's skirts.

Social Media or Third Party Site

Triggered by allowing a social media app, e.g., a Facebook™ app. Social media site acts as a proxy to serve applicant StarGreetz API personalization data that sends back personalized message, message plays in player in social media app. Can live outside of social media site on a site that allows users to authenticate via social media site.

Check-In

User checks into Starbucks® Coffee Shop, e.g., via Foursquare (www.foursquare.com). Foursquare tells applicant StarGreetz that they checked in someplace. StarGreetz matches userid and check-in and sends message to user—e.g., “Welcome to Starbucks® on corner of Olympic Avenue and Bundy Avenue in Los Angeles.”

(5) Delivery of Personalized Media Content

Distribution mechanisms for personalized messages, including: Outbound call—Personalized audio message delivered by telephone call or Voice Over IP (VoIP) call; social media applications (e.g., Facebook™, YouTube™, Foursquare, Twitter™, etc.); website or microsite; mobile website; email; mobile device apps, e.g., Android, iPhone, Java; electronic billboard and other digital signage content management system that manages display ads; and Quick Response (QR) Code.

(6) Personalized Message Playback with Automatic File Resolution Determination and Use

Content processing application encodes media clips to produce multiple formats of a personalized message that is multi-platform compatible and optimized. Multiple video qualities are supported for the personalized message including: Hi Definition—If opened on a high-def TV; Mobile—If opened on a phone, get a file that works on that medium; Computer—If opened on a laptop, desktop, or tablet computer.

The personalized message is wrapped in a URL that, when clicked, detects the web browser of the device that it is opened on. Based on device information, an API call is triggered that matches the appropriate quality with the target device.

Video Clips and Audio Clips table contain a field named Quality with possible values High, Medium, and Low representing the bit rate and resolution for video or audio encoding. The resulting three quality levels of the media clips are stored in the respective video clips or audio clips table.

(7) Server Interaction to Generate Personalized Message for Viewing in Thin Client Device

Mobile Apps as Distribution Mechanisms, e.g., iPhone, Android, Microsoft Windows Smartphone, Java

Applications are mobile interface for the personalization platform. This is the same interaction as on website, but looking at it through a mobile device app interface. Personalization works the same as on website and on mobile with no quality degradation.

Creation and Display of Personalized Message on a thin client device via interaction with multiple different servers

Able to take API and through different parts of interface, interact with different servers and then preview personalized content.

Overall Process of Personalization Delivery

Interface—user picks name and other info. App hits various servers for info and gets personalized message, e.g., database for tags, etc. Content processing application produces a personalized message. Media files are loaded into the Media File Server Product metadata is loaded into the Database Server. Web/Application Server contains software to present UI to user to personalize product and serves request for personalization to the Media Server. Media Server pulls clips from media file server, on request from the Web/Application Server and produces a personalized media file which is served to the user interface (or API) by the Web/Application Server.

(8) Web iFrame and Widget Use to Generate Personalized Message

One alternative embodiment includes the ability to provide a user interface for personalization to utilize same process regardless of location, e.g., personalized and buy from partner's website, from applicant StarGreetz website, etc., all via SG API. Examples include web iFrame which allows the web developer to include content from external sources inside a web page, or a graphical user interface (GUI) widget. This allows the ability to layer onto other websites, including the ability to order, preview, and purchase products using StarGreetz system although not through StarGreetz's website. Variable matching and personalization preferably happens via SG API.

Applicant StarGreetz provides a script library such as javascript or actionscript for a web developer to implement on a website. The library contains calls to the SG API to provide data inputs for personalization and output an iFrame URL that contains the personalized media. This iFrame can reside on a website, a mobile website, a microsite, inside a social media application such as a Facebook™ application tab.

(9) Delivery and Pick-Up of Personalized Message at Designated Location

Ability for a recipient to retrieve a personalized message personalized for him by a sender. Sender picks x variables, and configures personalization stream for recipient that includes unique identifiers such as email, phone number. Stream makes a personalized media clip when executed by Content Processing Application. Recipient provides system with one or more identifiers and gets a match from the SG Database. The recipient may need to enter the code/identifier in the interface to retrieve the personalized message made for him. System executes the stream and user views or listens to his personalized message.

When a sender personalizes a message for a recipient, via input of variables into a user interface, the interface makes API calls to the SG Database to retrieve options for the product script. Sender's inputs are sent to the SG Database via API call and system creates an envelope in the SG Database.

Envelopes Table contains an “Envelope ID” for each recipient of a personalized message. The “Status” field in the Envelopes Table indicate whether the recipient has picked up their message or not.

This same method can be used within the system as a batch process for a CRM database data based blast send of a personalized message for each recipient on a mailing Customer's CRM system sends the SG API a Customer ID and personalization data parameters (e.g., name, age, shopping history, etc.) for each recipient of a Product, SG API returns a pickup link to media that Customer can send via Twitter™, Facebook™, email, telephone, QR code, Near Field Communication (NFC), website, mobile device, or any other delivery mechanism. The link format is as follows:

www.URL.com/token

Where the URL is the URL where the web application resides, and token is the unique identifier for personalized media (MD5sum). The SG API can be accessed in a transactional manner or a batch manner accepting inputs and returning outputs in format of comma or delimited text files, XML or JSON.

(10) Recurring Nature of Personalized Message and Scheduling

Ability to schedule a recurring personalized message that is delivered at user specified times or intervals via a user interface that makes API calls to the SG Database. Some examples include: Personalized daily wake up calls—personalized each day differently (e.g., with day of week/weather); Personalized Updates and Alerts based on new information such as time, weather, or other automatically generated/retrieved data.

Implementation

Inside concatenated message there is an end card that is swapped out based on date or other info leading up to the end card, e.g., a countdown that is triggered by date, “new episode starts on April 8; new episode starts on Friday; new episode starting tonight.” Web application gets scheduling information from SG Database to rotate out media clips in certain positions within a message based on time or user upload, e.g., “All new lease offers for Toyota® Prius™ only for May.”

Delayed Job Table contains personalized media delivery scheduling information such as “Product ID,” time, and personalization parameters for each recipient of the messages.

Workflow in application determines variables with time or geographical triggers, e.g., day of the week determined by system clock or user location will be used to personalize the scheduled message for the user.

(11) Sponsored Message Delivery of Personalized Message or Sponsored Position Within a Personalized Message

A personalized message that is free to the end user but is paid for by a promotional sponsor who inserts one or more promotional media clips into product positions via CMS. For example, if instead of a user purchasing an eCard for $2.99, he personalizes it for free but the last position in the eCard says, for instance, “This message is brought to you by Redbull®,” or “Congrats on your recent engagement, sponsored by Bridal Magazine®.”

Configuration of the Promotional Positions in CMS

Sponsored message content is recorded, filmed and uploaded to the CMS according to the processes described above. This content may represent one or more media clips in one or more product positions within a message. The promotional positions are combined with the other positions to produce one seamless personalized message for the user.

Delivery of the personalized message containing promotional positions

Advertisement used is based on personalized info that is catalogued in a database. Content processing application produces a personalized message per process described above that is delivered to the user via the delivery methods described above.

(12) Application Programming Interface (API) for Creating and Delivering Personalized Messages

Application Programming Interface (API) provides methods for a software developer to use the following system functionality in their applications to deliver personalized messages:

“Introspect” data objects including products, positions, tags, variables, product metadata, Products Table in the database.

“Script and Template” their own products and persist these products to the SG Database in the Products Table.

“Configure User Interfaces” that the application developer provides to get user configured personalization data.

“Delivery Personalized Messages” via all the delivery methods specified above or via additional methods of his choosing, using the personalized message media file. Flags for delivery methods supported for a particular product (Products Table in the SG Database or the like).

Developer registers in the SG Database API table and obtains an authentication token for use of the API. System counts number of API calls developer makes and is able to report on usage for the purpose of billing and analytics.

There are endpoint extensions in the API for the web application as well as the content processing application. The API is housed and managed by a separate API server in the infrastructure.

The SG API can be accessed in a transactional manner or a batch manner accepting inputs and returning outputs in format of comma or delimited text files, XML, or JSON.

(13) Delivery of Personalized Message Based on Near Field Communication (NFC)

User configured or system configured personalized message delivery based on swiping a device with Near Field Communication (NFC) reader enabled and activated. NFC technology is disclosed in, for example, U.S. Patent Application Publication No. 2007/0265033 (Brostrom), titled “System and Method for Storing Near Field Communication Tags in an Electronic Phonebook,” which contents are incorporated by reference.

User Configured Message

User sees point of purchase promotion at a retail store or other point of interest on a map or physical location. User swipes his NFC enabled device on an NFC tag. Tag maps to a URL which is mapped to a product in the SG Database. User inputs variables via social media application allow or manual input of variables in a user interface form. Variables are passed to the SG API. Content processing application produces a personalized message per process described above that is delivered to the user via the delivery methods described above.

System Configured Message

User sees point of purchase promotion at a retail store or other point of interest on a map or physical location. User swipes his NFC enabled device on an NFC tag. Tag maps to a URL which is mapped to a product in the SG Database. Based on where the tag was scanned, associated variables are passed to the SG API. Content processing application produces a personalized message per process described above that is delivered to the user via the delivery methods described above. The tag may also direct user to a URL where he can pick up a message that was personalized beforehand by API calls from a CRM system to the SG API. The user's device or NFC reader application identifier matches the user with the message that was made for him.

System can personalize the message by knowing that a user scanned an NFC tag in a certain place both facts can be used in the message, e.g. “I see you are using a Google phone with NFC” and “I see you are there at Starbucks in Beverly Hills, Calif.”

(14) Personalized eCards Based on User Personalization of Paper Greeting Cards

Software to take user configured personalization data that a sender provides on a paper greeting card as an input to a digital personalized message delivered to a recipient specified by the sender.

User Configured Data Input

Sender of a paper greeting card purchased the greeting card. The greeting card contains a unique identifier numeric code or a QR code that represents a product in the SG Database. Additional form input boxes are printed on the back of the card. The input boxes represent positions in the product script and the sender writes in the values with a writing implement on the card. There is also and input box for recipient's email address for delivery. The user downloads a third party QR code or Optical Character Recognition (OCR) mobile or web application that makes use of the camera on his device. The scan takes the text input the sender has written into the input fields on the card and converts them into a digital string that is sent to the SG API. The input fields are matched to variables in a product script and are matched to a media clip for each position or matched to a default media clip, in the case of no match. API request with personalization parameters is sent to the Content Processing Application to generate a personalized message.

Recipient Pick-Up of the Personalized Message

Recipient gets personalized message via the delivery methods described above including email, social media wall post, etc.

(15) Personalized Internet Advertising

API methods to take input variables from ad networks or websites where ad networks server advertising and output a personalized message. There are methods for search advertising and display advertising.

Search Advertising

Personalization of product is initiated by user entry of search term into a search engine input box. Search terms plus other user data gathered in cookies are delivered to the SG API. The SG API returns a personalized message that is delivered to the ad server. Ad server creates a link to the personalized message and displays it to the user on the search results page where he entered his query.

Display Advertising

Personalization of product is initiated by user visit to a web page, mobile web page, web based television show, mobile application or any other location where an internet advertising network owns or manages real estate for display ads. User data gathered in cookies (system generated data) or via user are delivered to the SG API. The SG API returns a personalized message that is delivered to the ad server. Ad server creates a link to the personalized message and displays it to the user on the search results page.

User Input on a rich media ad whereby an ad server passes the data from the user to the SG API containing personalization parameters for assembly of a message. An ad server passes the data from a user's session, via stored cookies, to the SG API containing personalization parameters for assembly of a message. Cookies can store behavioral data on the user, e.g., what pages the user visited and pass them to the ad server which in turn, passes them to the SG API. Cookies can also store registration information on a user gathered by the website the user is on. This is also known as “first party data.”

Ad networks who use data service providers to augment the information used to target internet display ads can also pass this user data to the SG API for the purposes of assembling a personalized message.

(16) System to Facilitate Personalized User Recorded Messages

Web based software and API methods to allow any user with access to a web camera, Internet connectivity and editing software to script, record, upload to the CMS and deliver personalized messages.

Scripting

Software to assist user in script template creation. Web based wizard software takes user thru a step by step process of script template creation allowing users to add a position, configure the position type as static or variable, position duration and assign script labels to the variables. End result is a web based script template associated with a product created in the SG Database.

Recording

With the assistance of a script template loaded into a web browser, user uses a web camera or digital camera to record media clips. User can edit the clips using computer based or online third party software.

Uploading

API methods to upload user generated clips to product positions. Returns a success or failure in the case that an asset is too long or short for a specific position.

Delivery

Software to build an interface for product personalization by an end user based on user configured or system configured data described above. Delivery of the personalized message via methods described in delivery of personalized media content process above.

The system provides a graphical user interface to create or update a product via the Products Table. The Product Scripts table is also queried for each position and user records via webcam or microphone or uploads from his computer all the required component media clips for each position. These media clips are stored in the Audio Clips or Video Clips tables.

The Users Table in the SG Database stores all personalization parameters related to the message.

Various modifications may be made to the present invention without departing from the scope thereof. Although individual features of embodiments of the present invention may be shown or described in some of the drawings or discussions, respectively, and not in others, those skilled in the art will recognize that individual features of one embodiment of the invention can be combined with any or all of the features of another embodiment.

We claim:

1. A computer implemented method for retailers, brands, manufacturers, service providers, and resellers to deliver personalized messages based on a script about their products to an end user, wherein end user data has been collected via at least one of (1) end user input, (2) a social media database containing user input, (3) a CRM database query based on end user information, (4) cookies and browser header from the end user net surfing, and (5) second and third party data providers, the computer implemented method comprising:
a web application server accessing the end user data and storing on a local database;
a media server retrieving the end user data from the local database, the media server containing a content management system having at least one product template that is defined by the script applicable to multiple products;
the media server accessing a media file server containing media clips presenting a product and a position, and processing at least one media clip based on the product template from the content management system and the end user data to generate a personalized message;
a content distribution network receiving the personalized message from the media server and relaying the personalized message to the web application server; and
wherein the web application server delivers the personalized message to the end user.

2. The computer implemented method of claim 1, wherein the product template controls at least one of a timeline, a duration of a position, a total duration of the personalized message, and the media clip that is used in multiple locations of the product.

3. The computer implemented method of claim 1, wherein the product template is in the form of at least one of the following: ringtone, ringback, audio greeting, mobile alert, eCard, eInvitation, social media broadcast message, social media page welcome message, and CRM message.

4. The computer implemented method of claim 1, wherein the product template is encoded with a tag descriptive of at least one of a form of distribution and a position of the product.

5. The computer implemented method of claim 1, wherein the end user via the media server accesses and edits the product.

6. The computer implemented method of claim 1, wherein the media server includes a personalization stream, and a sender provides identifiers to the system to be matched with the end user data on the local database, and the stream and personalized message are processed so that the personalized message is delivered to the end user at a designated location.

7. The computer implemented method of claim 1, wherein the end user specifies times and time intervals that is stored in the local database, such that the web application server delivers the personalized message to the end user on a recurring basis.

8. The computer implemented method of claim 1, wherein the content management system inserts a promotional position into the personalized message.

9. The computer implemented method of claim 1, wherein a third party accesses the local database and via API call modify the end user data to at least one of creating and modifying the personalized message.

10. The computer implemented method of claim 1, wherein the product is accessed and edited by content management system based on information accumulated by the system including at least one of date, time, news, and weather.

11. The computer implemented method of claim 1, wherein the product is accessed and modified by the end user via at least one of QR code scan and social media website application.

12. The computer implemented method of claim 1, wherein a sender accesses the local database, the sender updates the local database with positions in the product script contained on a paper greeting card sent to the end user, and the end user via Optical Character Recognition and QR code triggers delivery of the personalized message.

13. The computer implemented method of claim 1, wherein the end user data received from cookies and browser header from the end user net surfing is combined with the end user data in the local storage via API call, and the API call to the media server generates a personalized message.

14. The computer implemented method of claim 1, wherein the end user accesses at least one of a web camera, internet connectivity, and editing software, to script, record, and upload to the content management system to at least one of adding a new position and modifying the position.

15. The computer implemented method of claim 1, wherein the end user uses at least one of iFrame and a widget to generate an API call to at least one of adding to and modifying the end user data contained in the local storage.

16. A computer implemented method for retailers, brands, manufacturers, service providers, and resellers to deliver personalized messages based on a script about their products to an end user, wherein end user data has been collected at least via one of (1) end user input, (2) a social media database containing user input, (3) a CRM database query based on end user information, (4) cookies and browser header from the end user net surfing, and (5) second and third party data providers, the computer implemented method comprising:
a web application server accessing the end user data and storing on a local database;
a media server retrieving the end user data from the local database, the media server containing a content management system having at least one product template that is defined by the script applicable to multiple products;
the media server accessing a media file server containing media clips presenting a product and a position, and processing at least one media clip based on the product template from the content management system and the end user data to generate a personalized message;
a content distribution network receiving the personalized message from the media server and relaying the personalized message to the web application server; and
wherein the web application server delivers the personalized message to the end user via at least one of the follow distribution mechanisms: an outbound telephone call, a social media application, a website, a microsite, an email message, a mobile application, wireless digital signage, Near Field Communication, and a QR code.

17. The computer implemented method of claim 16, wherein the media server encodes at least one media clip to produce multiple formats of a personalized message, wherein the formats include at least one of hi definition video, a mobile device compatible, and computer executable.

18. A computer implemented method for retailers, brands, manufacturers, service providers, and resellers to deliver personalized messages based on a script about their products to an end user, wherein end user data has been collected at least via one of (1) end user input, (2) a social media database containing user input, (3) a CRM database query based on end user information, (4) cookies and browser header from the end user net surfing, and (5) second and third party data providers, the computer implemented method comprising:
a web application server accessing the end user data and storing on a local database;
a media server retrieving the end user data from the local database, the media server containing a content management system having at least one product template that is defined by the script applicable to multiple products;
the media server accessing a media file server containing media clips presenting a product and a position, and processing at least one media clip based on the product template from the content management system and the end user data to generate a personalized message;
a content distribution network receiving the personalized message from the media server and relaying the personalized message to the web application server; and
wherein a mobile application resident on an end user's mobile device receiving and playing the personalized message.

19. A computer implemented method for retailers, brands, manufacturers, service providers, and resellers to deliver personalized messages based on a script about their products to an end user, wherein end user data has been collected via at least one of (1) end user input, (2) a social media database containing user input, (3) a CRM database query based on end user information, (4) cookies and browser header from the end user net surfing, (5) second and third party data providers, and (6) near field communication, the computer implemented method comprising:
a web application server accessing the end user data from the near field communication the end user data including at least one of a purchase promotion, a map location, a physical location, from the near field communication;
storing the end user data on a local database;
a media server retrieving the end user data from the local database, the media server containing a content management system having at least one product template that is defined by the script applicable to multiple products;
the media server accessing a media file server containing media clips presenting a product and a position, and processing at least one media clip based on the product template from the content management system and the end user data to generate a personalized message;
a content distribution network receiving the personalized message from the media server and relaying the personalized message to the web application server; and
wherein the web application server delivers the personalized message to the end user.

20. The computer implemented method of claim 19, wherein the end user data from the near field communication includes data received from an NFC tag.
